(19) United States
(12) Patent Application Publication
(10) Pub. No.: US 2007/0239675 A1
(43) Pub. Date: Oct. 11, 2007

(54) Web search media service

(75) Inventors: Robert J. Ragno, Kirkland, WA (US); Christopher J. Burges, Bellevue, WA (US); Rohit V. Wad, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/391,817

(22) Filed: Mar. 29, 2006

(51) Int. Cl. G06F 17/30

(52) U.S. Cl. 707/3

(57) ABSTRACT

The subject disclosure pertains to Internet or web search engines and more particularly toward a media service integrated or associated therewith. The media service can identity particular media queries as well as provide and present useful information in an easily accessible manner. The search engine can therefore provide a common ground for people to locate things they perceive with respect to media (e.g., advertisements, music, video . . . ) and further facilitate purchase of media items and/or related content or items.

### CROSS REFERENCE TO RELATED APPLICATION

This application is related to U.S. application Ser. No. 10/180,271, filed on Jun. 25, 2002 and entitled SYSTEM AND METHOD FOR NOISE-ROBUST FEATURE EXTRACTION, which is incorporated herein by reference.

### BACKGROUND

The Internet and the World Wide Web continue to expand rapidly with respect to both the volume of information and the number of users. The Internet is a collection of interconnected computer networks. The World Wide Web, or simply the web, is a service that connects numerous Internet accessible sites via hyperlinks and Uniform Resource Locators (URLs). As a whole, the web provides a global space for accumulation, exchange and dissemination of information. The increase in usage is largely driven by the increase in available information pertinent to the needs of users.

To maximize the likelihood of locating relevant information amongst an abundance of data, Internet or web search engines are regularly employed. In some instances, a user knows the name of the site, server or the URL to the site or server that the user desires to access. In such situations, the user can access the site, by simply entering the URL in the address bar of a browser and connecting to the site. However, in most instances, the user does not know the URL or the site name that includes desired information. To find the site of interest, the user employs a search engine to facilitate locating and accessing sites based on keywords and operators provided by the user.

A web search engine, or simply “search engine,” is a tool that facilitates web navigation based on the entry of a search query comprising one or more keywords. Upon receipt of a query, the search engine retrieves a list of websites, typically ranked based on relevance to the query. To enable this functionality, the search engine must generate and maintain a supporting infrastructure.

First, search engine agents, often referred to as spiders or crawlers, navigate websites in a methodical manner and retrieve information about sites visited. For example, a crawler can make a copy of all or a portion of websites and related information. The search engine then analyzes the content captured by one or more crawlers to determine how a page will be indexed. Indexing is the transformation of the website data into a form, the index, that can be easily employed at search time. Some engines will index all words on a website, while others may only index terms associated with particular tags (e.g., title, header, metatag . . . ). Crawlers must also periodically revisit webpages to detect and capture changes since the last indexing.

Upon entry of one or more keywords as a search query, the search engine retrieves information that matches the query from the index, ranks the sites that match the query, generates a snippet of text associated with matching sites and displays the results to a user. The user can thereafter scroll through a plurality of returned sites to attempt to determine if the sites are related to the interests of the user. However, this can be an extremely time-consuming and frustrating process as search engines can return a substantial number of sites. More often then not, the user is forced to narrow the search iteratively by altering and/or adding keywords and operators to obtain the identity of websites including relevant information.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject innovation pertains to a search engine service that supplies valuable information with respect to media queries. This service can provide added value to a search engine by attracting and encouraging users to continue to utilize the engine for various types of web queries including media and non-media queries. The information can be provided by one or more entities including but not limited to Internet and broadcast media companies. The supplied information can include information that may or may not be otherwise available on the web.

In any event, the subject innovation provides a unified and easy mechanism for locating and interacting with media information. Accordingly, even if the information is publicly accessible via the web, a user may not know where it is located. Moreover, utilizing a conventional search engine to attempt to discover the information can be extremely time consuming, as a user needs to wade through a plethora of provided query results with only a possibility of locating what the user desires.

In accordance with an aspect of the subject innovation, a search engine includes or is communicatively coupled to a media service component. The media service component can include a query identification component that determines if a query is a media query. The media service component can also include a query augmentation component that can influence the identified query, and thus the returned results, based on the query itself, amongst other things. The augmented query can subsequently be provided to a processor to evaluate the query with respect to one or more data repositories. The results of the processed query can then be provided to a user. The results can include special information provided by a media entity alone or in combination with conventional search results.

The supplier provided information can relate to media items such as text, audio, and video or a combination thereof. According to an aspect of the innovation, the information can provide links to a website where the items can be downloaded for a fee or free. For example, assume Tom is driving home from work listening to the radio and he hears a song he likes, but does not know the name of the song, artist or other identifying information. Subsequently, he employs a search engine and enters the call numbers of the radio station on which he heard the song. The media service component can present Tom with a list of the last number of songs played by that station. He can then click on the song to be transported to an online music store where the song can be purchased or other related items explored.

Information suppliers or entities can be encouraged to provide valuable information and features in many ways. According to one aspect of the innovation, the entities can be credited with a fee such as a portion of the revenue generated by purchases resulting from their content. Additionally or alternatively, the entities can be allocated free or discounted advertisement space in conjunction with the provided content. Another option is to collect and supply entities with data regarding the interaction with supplied information and/or other demographical data.

In accordance with another aspect of the subject innovation, a query can be influenced based on media content. The content of one or more communications mediums can be monitored and queries influenced based thereon. For example, a user can specify that query results be biased with respect to a particular media at a specific time.

According to yet another aspect of the innovation, a query can be influenced based on specified preferences. User media preferences can be manually specified and/or automatically determined. Accordingly, a user is able to submit a query for a particular communication medium in a location that satisfies local preferences.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a web search engine with associated media service component.

FIG. 2 is a block diagram of an interface component.

FIG. 3 is a block diagram of a media service component.

FIG. 4 is a block diagram of a query augmentation component.

FIG. 5 is an exemplary screenshot of a query response page.

FIG. 6 is a block diagram of a media service component including a media monitor.

FIG. 7 is a block diagram of a media service component including a preference filter.

FIG. 8 is a block diagram of a media service component including a selection component.

FIG. 9 is a flow chart diagram of a media service method.

FIG. 10 is a flow chart diagram of a search engine method.

FIG. 11 is a schematic block diagram illustrating a suitable operating environment for aspects of the subject innovation.

FIG. 12 is a schematic block diagram of a sample-computing environment.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

As used in this application, the terms “component” and “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Artificial intelligence based systems (e.g., explicitly and/or implicitly trained classifiers) can be employed in connection with performing inference and/or probabilistic determinations and/or statistical-based determinations as in accordance with one or more aspects of the subject innovation as described hereinafter. As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus, or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

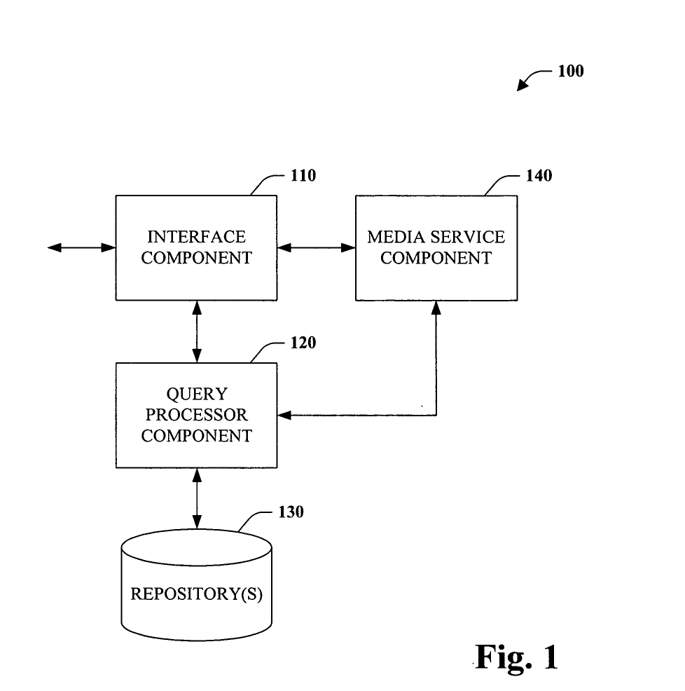

Referring initially to FIG. 1, a web search engine 100 is illustrated in accordance with an aspect of the subject innovation. The search engine 100 includes an interface component 110, a query processor component 120, a repository(s) 130 and a media service component 140. The interface component 110 can present and receive data from users. In other words, the component 110 is a type of human-computer interface. For example, the interface component 110 can provide or generate web pages that can receive web queries and provide results. The web queries can be of various types including but not limited to Boolean and natural language queries.

The interface component 110 is communicatively coupled to the query processor component 120. The query processor component 120 evaluates or processes queries with respect to one or more repositories 130. In one instance, a web search query can be evaluated with respect to an index or plurality of indexes housed in repository 130 as is known in the art. However, the subject innovation is not so limited, as the query processor component 120 can request and retrieve data of various forms and formats stored on the repository(s) 130.

The interface component 110 and query processor component 120 can also be coupled to a media service component 140. The media service component 140 can provide unique functionality with respect to media queries including but not limited to queries pertaining to radio and televisions stations. More specifically, the media service component 140 can receive, retrieve or otherwise monitor user web queries input utilizing interface component 110 and retrieve, via employment of query processor component 120, additional media information based at least in part on the query and media type. This additional information can be provided alone or in conjunction with query traditional web query results. The information can include data that is and/or is not available elsewhere on the web. For example, if a web query corresponds to a radio station's call letters, then a selectable listing of the most recently played songs and/or advertisements could appear in addition to conventional search page results. Additionally or alternatively, the media service component 140 can be employed to influence the results of a query as will be described in latter sections.

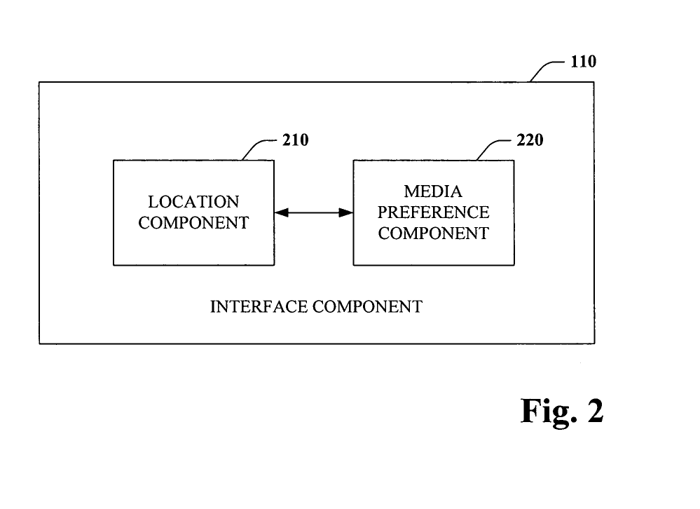

FIG. 2 illustrates an interface component 110 in accordance with an aspect of the subject innovation. The interface component 110 includes a location component 210. The location component 210 is operable to determine a geographical location from which a search is being requested. In a simple implementation, the location component 210 can simply retrieve a location from a user. For example, the interface component 110 may display a field for entry of city, state and/or zip code. If not provided, the location component 210 is able to determine or infer a geographical location. For example, the location may be able to be determined from the Internet Protocol (IP) address. Additionally or alternatively, the component 210 can employ more sophisticated mechanisms to identify geographical location including but not limited to global positioning system (GPS) and/or wireless triangulation.

Interface component 110 can also include a media preference component 220. The media preference component 220 receives, determines and/or persists media preferences for individual users or computers. For example, a user may specify that they like a particular television show. This information can be received and stored by media preference component 220. Additionally or alternatively, the media preference component 220 can infer a preference for soft rock based on searches for particular songs or radio stations. Still further yet, the media preference component 220 can be communicatively coupled to the location component 210. Thus, the media preference component 220 can associate preferences with one or more locations. For instance, a user may prefer radio station “A” in city “A” and radio station “B” in city “B.” Note also that preference component 220 can utilize specific preferences to generate more general preferences, or more general preferences to identify preferences that are more precise, automatically. Consider a more specific example, where a user is determined by location component 210 to be located in Seattle and by preference component 220 to prefer classic rock. In this scenario, the system 100 of FIG. 1 can provide the user with the last ten songs played by one or more Seattle classic rock stations (e.g., KZOK) alone or in conjunction with advertisements recently mentioned by the station (e.g., selling concert tickets . . . ).

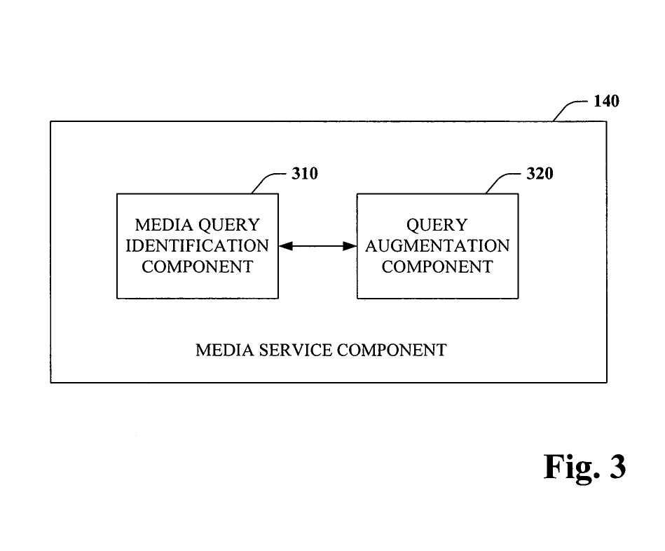

Referring to FIG. 3, a media service component 140 is illustrated in accordance with an aspect of the subject innovation. The media service component 140 can include both a media query identification component 310 and a query augmentation component 320. The query identification component 310 is operable to identify media queries. In one scenario, query identification component 310 can monitor queries received by the search engine and determine if they are media queries. Amongst other ways, this can be accomplished by identifying particular search terms such as radio and television station call letters. A media query can also be identified as such utilizing one or more keywords such as “media” preceding or following search terms. Such a keyword can be specified manually by a user or inserted automatically by the interface when query is entered in a particular space or media option is selected. For example, a search engine may provide a separate query input box for media queries that automatically adds one or more keywords. Accordingly, the media query identification component 310 can simply search for one or more keywords to identify a query as a media query. It is also to be noted that the media query identification component 310 is also operable to identify a type or category of media query. For example, it can identify a media query as of type radio, television or both. Once a media query is detected by the query identification component 310, the query augmentation component 320 can be notified and data transferred thereto or otherwise made available for access by the augmentation component 320.

Upon acquiring a media query from the identification component 310, the query augmentation component 320 is operable to influence the query return results. More specifically, the query augmentation component 320 can modify the query provided for processing. For example, the query can be further restricted or expanded. Queries can also be generated by the augmentation component 320 that retrieve or attempt to retrieve particular information not necessarily available publicly over the web or forming a portion of a conventional indexed webpage. For instance, media companies can be given incentive to provide useful information to a search engine company that can be provided to users alone or in conjunction with traditional search results. Such a unique feature promotes search engine loyalty amongst users in a relatively fungible market. Additionally or alternatively, audio and video fingerprinting technology can be employed to generate valuable information such as playlists. Furthermore, it is to be noted that query augmentations made by component 310 can depend upon a media query type, amongst other things.

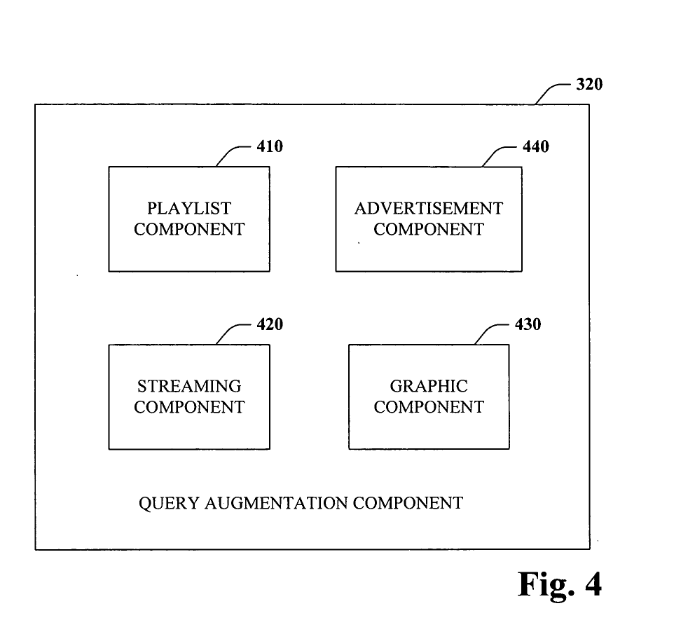

Turning attention to FIG. 4, an exemplary query augmentation component 320 is illustrated in accordance with an aspect of the subject innovation. Query augmentation component 320 includes playlist component 410, stream component 420 and graphic component 430. Playlist component 410 can retrieve a list of media items relevant to the query. The media items can correspond to text, audio and/or video including but not limited to songs, television shows, commercials and news clips. Furthermore, these media items can be associated with other web pages such that selection of a listed media item will transport a user to another page, for instance for playing and/or purchasing such an item. Stream component 420 retrieves a link to streaming audio and/or video associated with the media query, such as a live broadcast. Graphic component 430 can retrieve a graphic associated with a media query item such as a logo or trademark.

Query augmentation component 320 also includes an advertisement component 440. Advertiser component 440 can retrieve one or more advertisements or links to companies designated by a media entity or company. Since the improved functionality of the search engine can be due in part to information provided by third parties such as media companies, the search engine can reserve at least a portion of the results page for advertisements designated by such entities. These advertisements can be in addition to those displayed based on query keywords. Such advertisement space is highly valuable and will therefore provide increased advertising revenue for information supplying entities. Accordingly, there is an incentive to provide specialized information to a search engine. Of course, other incentives can be employed alone or in conjunction with free advertisements. For example, entities can be provided a portion of any revenue generated based on the supplied information (e.g., media items, advertisements . . . ).

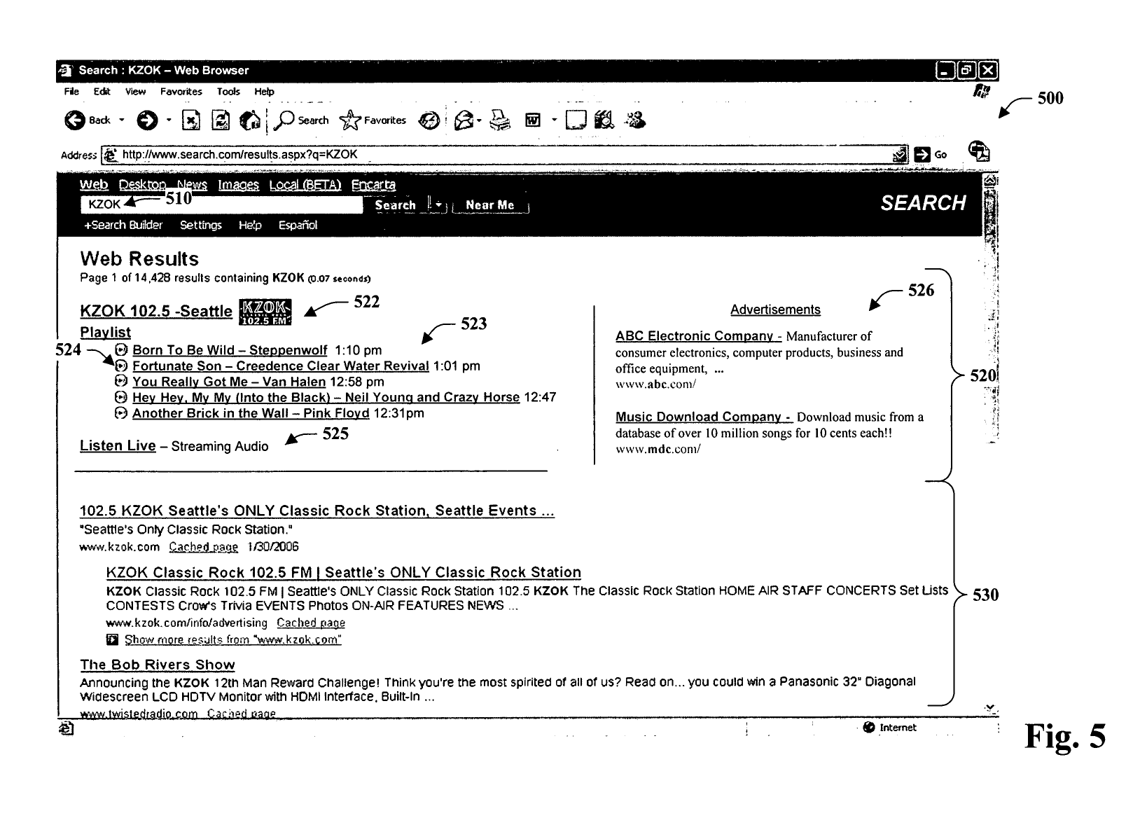

FIG. 5 depicts a screenshot 500 of an exemplary query response page that can be displayed in accordance with aspects of the subject innovation. Of course, the subject innovation is not limited to this particular output. This is just one of a number of ways that such graphical elements can be combined and arranged and is presented for purposes of clarity and understanding. Screenshot 500 corresponds to a search for radio station call letters. In particular, screenshot 500 is returned in response to a query for “KZOK” as provided in the search box 510. The response is composed of two main portions 520 and 530. Portion 520 corresponds to the piece of the response that is generated based on information retrieved by the media service component 140 while portion 530 relates to conventionally returned results. As shown, the generated response includes a link to the radio station queried including a graphical element of the stations logo 522. Upon selection, these elements can transport a user to the radio stations homepage. Additionally, supplied is a playlist 523 that includes the last five songs played by the radio station as of the time of the query. Associated with each song is a graphical play element 524. Upon selection of play element 524 at least a portion of the song can be played. Selection of a link identifying a song can transport a user to a website where that song can be purchased. At least a portion of revenue generated from song purchase in this manner can be credited to the radio station, here “KZOK,” to encourage them to continue to supply up-to-date playlists. Also displayed in portion 520 is a link to a live feed of the radio station 525. Upon selection, streaming audio of the radio station can be played. Still further yet, portion 520 includes a pair of advisements 526. These advertisements can be designated by the radio station for display and/or simply pertinent to the media content displayed. As described supra, this can also provide a very valuable incentive to provide information. In particular, the advertisement space could be sold to advertisers by the content supplier or alternatively the content supplier could be provided revenue associated with pertinent ads, for instance based on click through and/or purchase.

It should be appreciated that there are a number of examples in which the system 100, as described above, can be utilized to make it easy for users to buy things they heard or saw with respect to media. For instance, users could simply specify a search for “KZOK Tickets” with respect to a search engine to pick up concert tickets as advertised, and rely on the search engine to provide a special URL that was provided by the radio station to handle the sale. It is much easier for people to remember this, than to remember a particular page they should go to for each advertisement interesting ad. Further, the ad/search engine connection need not be explicitly specified. For example, a user can simply type in “KZOK Home Loans,” because she heard an ad for a home loan that was just played on the station. Here, the search engine can just serve up the ad provided by the station. The URL can be updated in real time (like the playlist). Additionally, the web page can contain a special deal that was mentioned in just one advertisement. The same functionality is applicable to television. For example, a user sees an advertisement for Carnival Cruise on TV, types in the name of the show they are watching and “Carnival Cruise,” and is given a URL with the special deal that the advertisement presented. It is to be appreciated that people are becoming sufficiently comfortable with search that they are likely to prefer going directly to a web page, rather than calling a phone number.

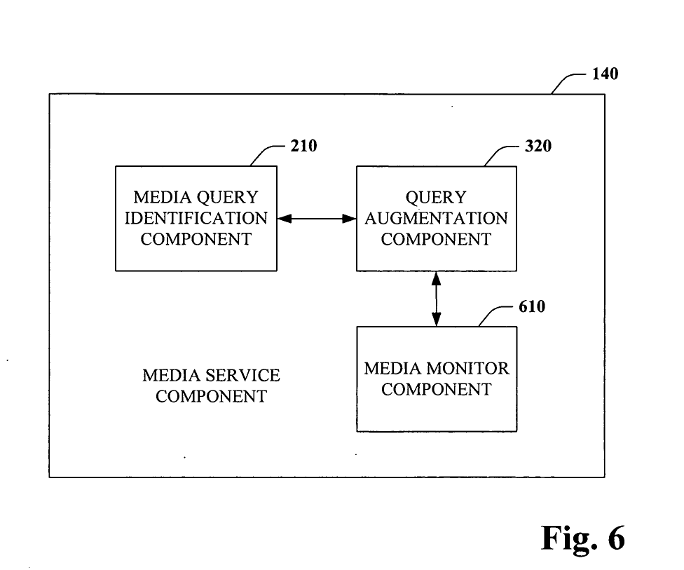

Referring to FIG. 6, the media service component 140 is illustrated in accordance with another aspect of the subject innovation. Here, the media service component 140 includes media query identification component 210 and query augmentation component 220 as previously described. In brief, the media query identification component 210 monitors web search queries to detect particular type of query such as a media query. Identified queries are then provided to the query augmentation component 220 that influences the query to be processed and thereby the results to be returned.

In addition to these components, media service component 140 includes a media monitor component 610 communicatively coupled to the query augmentation component 220. Media monitor component 610 can monitor one or more communication mediums such as but not limited to radio stations, television stations, and electronic periodicals. This can be accomplished utilizing among other things fingerprinting technology known in the art. All or a portion of such gathered information can be provided to the query augmentation component 320 to influence the query results. By way of example and not limitation, a user can select a communication medium like television or more particularly a specific station. A user can then enter web search queries the results of which will be influenced by the content provided by the particular communication medium. For instance, if they entered the search terms “washer and dryer” and a commercial for a particular vendor was recently shown, then results will likely include a link to that vendor. Furthermore, it is to be noted that a user need not designate a particular communication medium. In such an instance, the media monitor component 610 can simply monitor the most popular media sources at the time and influence queries based thereon. Note also that display of influenced results can be in addition to or as an alternative to convention un-influenced results. For example, influenced results can be provided in a media portion as illustrated in FIG. 5 (520).

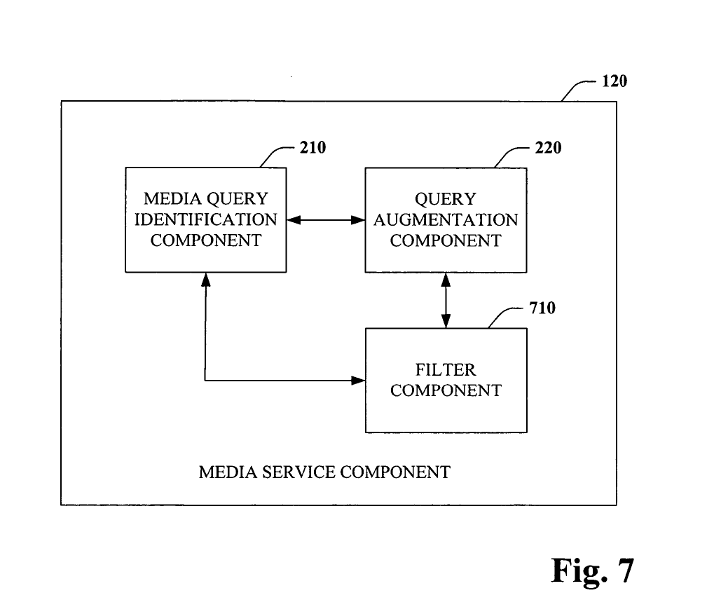

FIG. 7 illustrates a media service component 140 in accordance with yet another aspect of the subject innovation. Again, media service component 140 includes the media query identification component 210 and the query augmentation component 220. The media query identification component 210 identifies a particular type of query and the query augmentation component 220 influences the query results based on the query and other factors. Media service component 140 also includes a filter component 710 communicatively coupled to the media identification component 210 and the query augmentation component 220. The filter component 710 can provide user preference information and/or specific mapped data to the query augmentation component 220 with respect to a particular web query to influence the results based thereon. For example, a user can specify a web query for radio stations in a particular city. The filter component 710 can identify user preferences related to that query and provide the augmentation component 220 with those preferences (e.g., classic rock). Additionally or alternatively, the filter component can employ a map of users preferred local radio stations to similar stations different cities and provide the identity of such stations to the configuration component 120. The results generated can identify radio stations that the user would like in the specified city based on their media preferences.

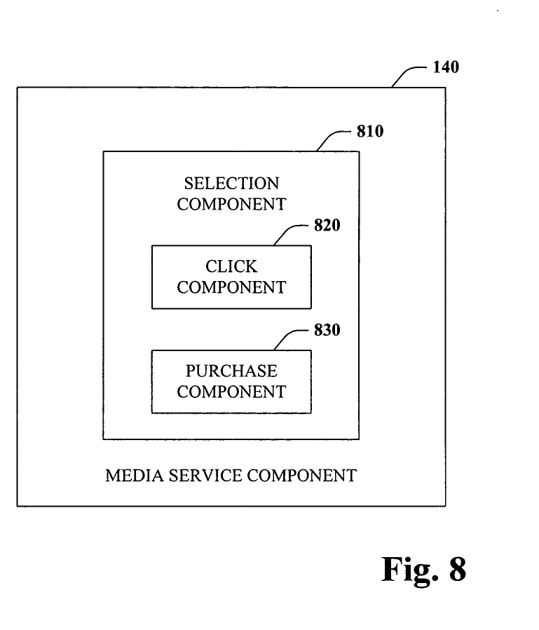

Turning attention to FIG. 8, a media service component 140 is illustrated in accordance with an aspect of the subject innovation. The media service component 140 can include a selection component 810. Selection component 810 can monitor user interaction with data provided by the media service component 140. In particular, the selection component 810 can include a click through component 820 that monitors which links were selected by users by clicking. This information can be provided to and employed by a media entity. For example, the information may reveal that one song is more popular than another. This can be utilized by a media entity to adjust the playlists for the songs they are playing, for example. Additionally, the selection component 810 includes a purchase component 830 that monitors purchases that result from content provided by the media service component 140. For instance, a user may select a song from a playlist provided by the service and subsequently be transported to an online store where the user can purchase the song. This action can be tracked and utilized to provide media entities a portion of the revenue generated from the purchase of the song. This in turn can be used to provide incentives to media entities, for example to contribute real time data that the service needs.

The aforementioned systems have been described with respect to interaction between several components. It should be appreciated that such systems and components can include those components or sub-components specified therein, some of the specified components or sub-components, and/or additional components. For example, the media service component 140 can include the query identification component 310, query augmentation component 320, media monitor component 610, filter component 710 and selection component 810 or a combination thereof. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

Furthermore, as will be appreciated, various portions of the disclosed systems above and methods below may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, media preference component 220 can infer or predict user preferences.

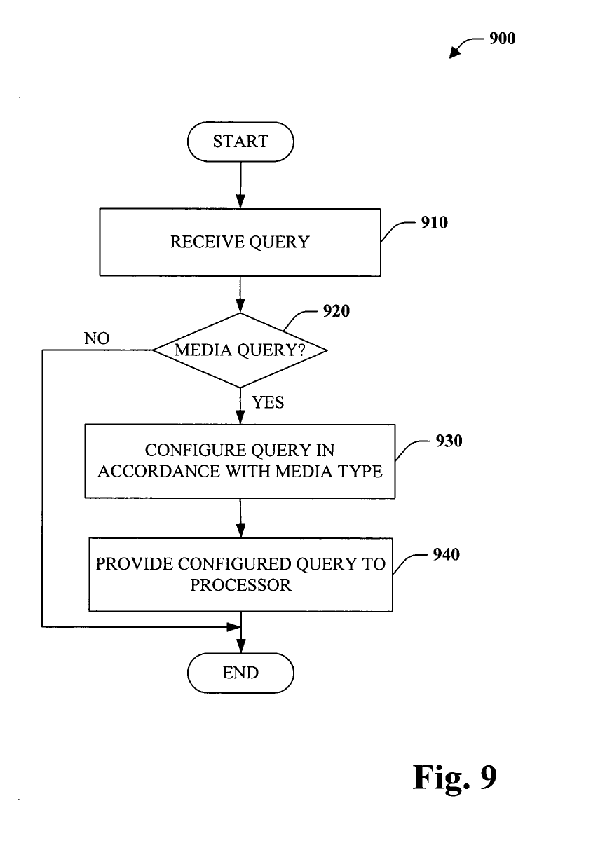

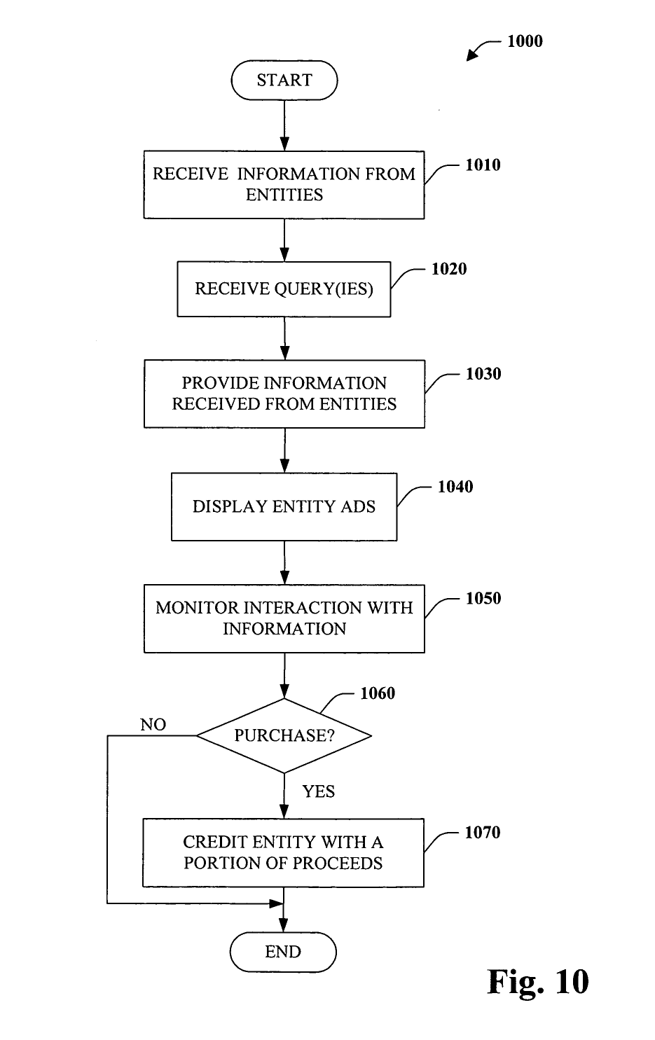

In view of the exemplary systems described supra, methodologies that may be implemented in accordance with the disclosed subject matter will be better appreciated with reference to the flow charts of FIGS. 9-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning attention to FIG. 9, a media service method 900 is illustrated in accordance with an aspect of the subject innovation. At reference numeral 910, a query is received or retrieved. At numeral 920, the query is analyzed to determine whether it is query of a particular kind such as a media query. If not, then the method terminates. If yes, the method continues at 930. At reference numeral 930, the query is augmented in accordance with the type of query received. For example, if the query is a radio query an additional query can be added to retrieve a playlist of songs that were played most recently or within a specified time period. Similarly, if the query pertains to a television station a playlist of recently aired shows, commercials and the like or and/or a schedule of upcoming programming can be displayed. The query augmentation can also be based on information provided from additional processes. For instance, the query augmentation can be influenced by currently playing media and/or preferences, among other things. At numeral 940, the augmented query can be provided to a query processor for execution.

FIG. 10 depicts a flow chart diagram of a search engine method 1000 in accordance with an aspect of the subject innovation. At reference numeral 1010, information is received from an entity, for example, a media entity such as a radio or television station and stored. Information can include useful data that may or may not be available over the web and optionally some advertisements or identification of advertisers. At numeral 1020, queries are received by the search engine method for processing. At 1030, at least a portion of the information provided by the entities is provided in response to the query. For example, a list of the most recent songs played by a radio station can be provided. Advertisements designated by the entity can be displayed together with the provided information at 1040. At reference numeral 1050, interaction with the provided information is monitored to determine if purchases result from the information. By way of example, the list of songs may be linked to an online store where the songs may be purchased. At 1060, a determination is made as to whether a purchase results from information. If yes, a portion of the proceeds are credited to the information supplying entity and the method terminates. If no, the method simply terminates.

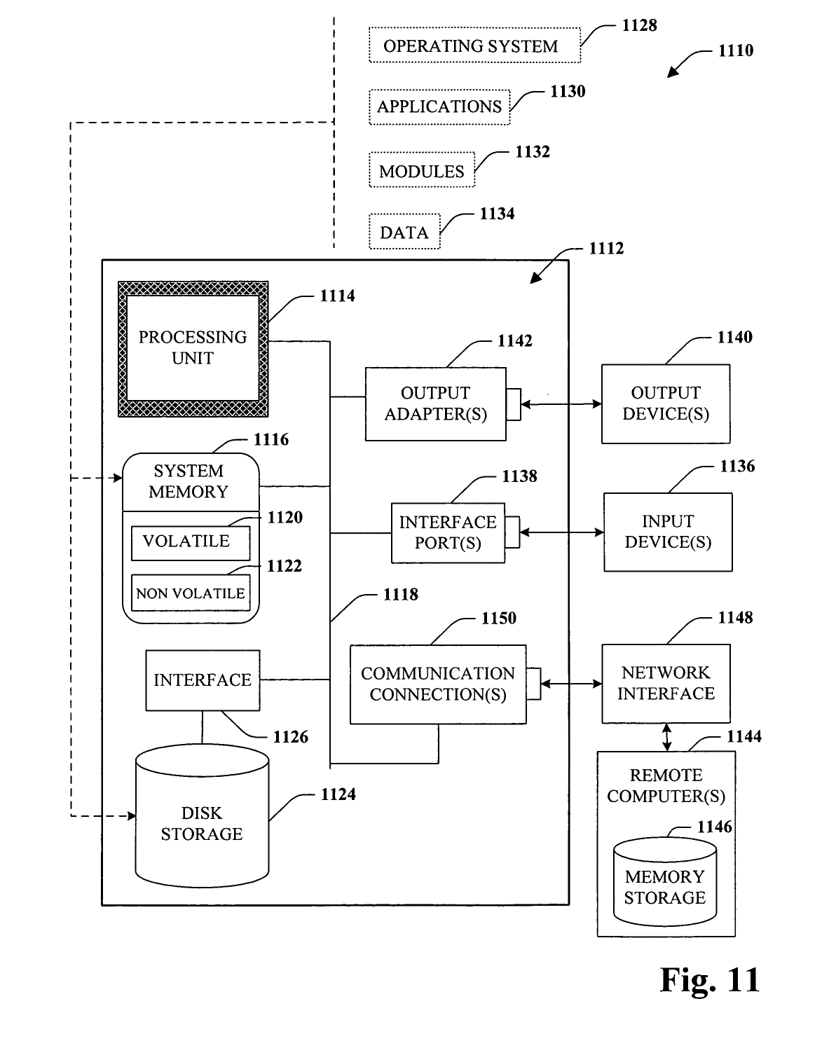

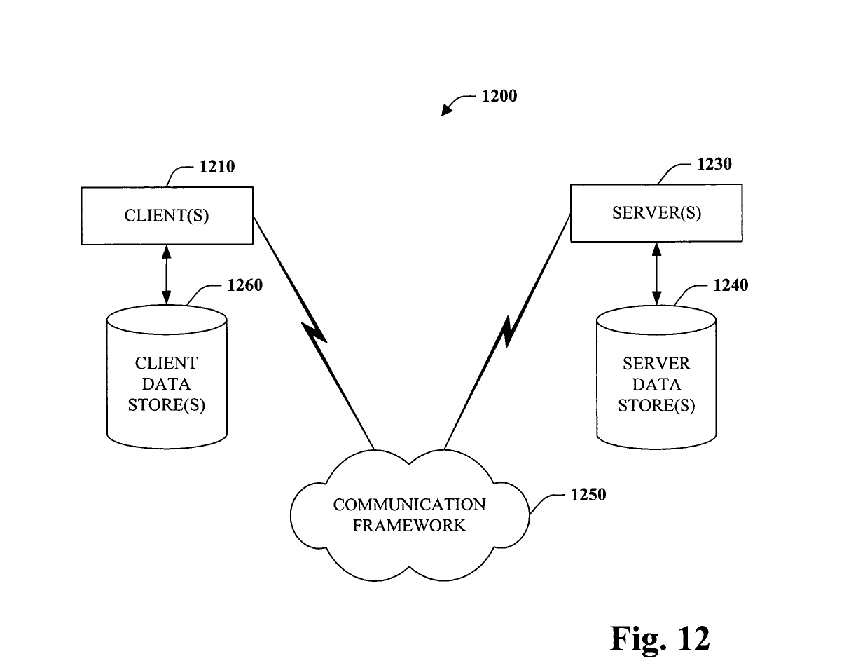

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 11, an exemplary environment 1110 for implementing various aspects disclosed herein includes a computer 1112 (e.g., desktop, laptop, server, hand held, programmable consumer or industrial electronics . . . ). The computer 1112 includes a processing unit 1114, a system memory 1116, and a system bus 1118. The system bus 1118 couples system components including, but not limited to, the system memory 1116 to the processing unit 1114. The processing unit 1114 can be any of various available microprocessors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable ROM (EEPROM), or flash memory. Volatile memory 1120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1112 also includes removable/non-removable, volatile/non-volatile computer storage media. FIG. 11 illustrates, for example, disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in suitable operating environment 1110. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the present invention can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112 and to output information from computer 1112 to an output device 1140. Output adapter 1142 is provided to illustrate that there are some output devices 1140 like displays (e.g., flat panel and CRT), speakers, and printers, among other output devices 1140 that require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1116, it can also be external to computer 1112. The hardware/software necessary for connection to the network interface 1148 includes, for exemplary purposes only, internal and external technologies such as, modems including regular telephone grade modems, cable modems, power modems and DSL modems, ISDN adapters, and Ethernet cards or components.

FIG. 12 is a schematic block diagram of a sample-computing environment 1200 with which the subject innovation can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the subject innovation, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A web search engine comprising the following computer-implemented components:
an interface component that receives a query and displays results provided by a query processor; and
a media service component that identifies a media query provided to the interface component and augments the query provided to the query processor to return information based on the media query.

2. The search engine of claim 1, the interface component displays the identity of a predetermined number of media items played by a broadcast entity identified in the query.

3. The search engine of claim 2, the broadcast entity is identified by its call letters.

4. The search engine of claim 3, the broadcast entity is one of a radio station and a television station.

5. The search engine of claim 2, the media items are identified by links that transport a user to a webpage where that media item can be purchased.

6. The search engine of claim 5, a visual or textual element is associated with the media item, selection of which initiates play of at least a portion of the media item.

7. The search engine of claim 2, the interface component provides a link to a live broadcast feed.

8. The search engine of claim 2, the interface component displays one or more advertisements designated by the broadcast entity identified by the query.

9. The search engine of claim 1, the media service component includes a monitor component that monitors local broadcasts and influences the query interface and/or results based at least on content of the broadcasts.

10. The search engine of claim 1, the media service component includes a filter component that facilitates query augmentation to match a broadcast entity in a first locality to one or more similar broadcast entities in a second locality.

11. A system for processing media searches comprising:
a computer-implemented means for identifying media queries from an Internet web query; and
a computer-implemented means for configuring the queries to retrieve specialized media information based on the query and media type.

12. The system of claim 11, further comprising a computer-implemented means for displaying retrieved query information to a user.

13. A method of retrieving media information comprising the following computer-implemented methods:
receiving an Internet search engine query;
identifying a media query; and
configuring the query to retrieve media information provided by an entity.

14. The method of claim 13, further comprising providing the augmented query to a query processor.

15. The method of claim 14, further comprising displaying results to a user.

16. The method of claim 15, configuring the query to retrieve a recent playlist where the media query identifies a radio station.

17. The method of claim 16, transporting a user to a website that enables an electronic version of a selected playlist song to be purchased.

18. The method of claim 17, crediting a radio station with a portion of the proceeds generated from the sale of a song.

19. The method of claim 16, further comprising displaying advertising links specified by the radio station.

20. The method of claim 13, the query is augmented to retrieve one of playable news and traffic reports for a locality specified in connection with the search engine query.
